(19) United States
(12) Patent Application Publication
(10) Pub. No.: US 2013/0284794 A1
(43) Pub. Date: Oct. 31, 2013

(54) METAL BONDING APPARATUS

(71) Applicant: SANYO Electric Co., Ltd., (US)

(72) Inventors: Takashi SUZUKI, Osaka (JP); Kouichi SAITOU, Ogaki-shi (JP); Yasuyuki YANASE, Hashima-shi (JP)

(73) Assignee: SANYO ELECTRIC CO., LTD., Osaka (JP)

(21) Appl. No.: 13/772,208

(22) Filed: Feb. 20, 2013

Related U.S. Application Data
(63) Continuation of application No. PCT/JP2012/005425, filed on Aug. 29, 2012.

(30) Foreign Application Priority Data
Aug. 31, 2011 (JP) 2011-189244

(51) Int. Cl. B23K 20/24; B23K 20/02

(52) U.S. Cl. CPC B23K 20/24; B23K 20/023
USPC 228/33

(57) ABSTRACT

The metal bonding apparatus comprises: a solution supply unit configured to supply a solution which is able to elute an oxide with copper oxide as a principal component, to at least one of a first bonding portion and a second bonding portion; a pressing unit configured to apply pressure to the first bonding portion and the second bonding portion so as to sandwich the solution between the first bonding portion and the second bonding portion, and in a direction in which a distance between the first bonding portion and the second bonding portion is reduced; and a heating unit configured to heat the first bonding portion and the second bonding portion, wherein the first bonding portion and the second bonding portion are bonded by the pressure applied by the pressing unit and the heat from the heating unit.

### RELATED APPLICATIONS

This application is a Continuation of International Application No. PCT/JP2012/005425, filed on Aug. 29, 2012, which in turn claims the benefit of Japanese Application No. 2011-189244, filed on Aug. 31, 2011, the disclosures of which Applications are incorporated by reference herein.

### BACKGROUND OF THE INVENTION

1. Field of the Invention

The present invention relates to a metal bonding apparatus, and more specifically, relates to a copper-copper bonding apparatus.

2. Description of the Related Art

As an electrically conductive material used to form a wiring layer that is a component of a wiring substrate, or used to form an electrode surface of each electrode of a semiconductor chip or the like, copper is widely employed.

As a conventional metal bonding method for electrically connecting a first bonding member to be bonded such as a wiring layer of a wiring substrate or the like to a second bonding member to be bonded such as an element electrode of a semiconductor chip, examples of such a conventional metal bonding methods include: a method in which the bonding faces are solder-bonded via solder; a method in which the bonding faces are bonded to each other by applying pressure while heating the bonding faces at a high temperature; and a method in which the bonding faces are activated by means of ion irradiation or the like in a vacuum so as to bond the bonding faces to each other; and so forth.

With such a conventional method in which copper-copper bonding is performed via soldering, there is room for further improvement of reliability of connection at a bonded portion. On the other hand, with such a conventional method in which the faces to be bonded are heated at a high temperature, such an arrangement leads to a risk of damage of a wiring substrate or a semiconductor chip.

### SUMMARY OF THE INVENTION

An embodiment of the present invention relates to a metal bonding apparatus. The metal bonding apparatus comprises: a solution supply unit configured to supply a solution which is able to elute an oxide with copper oxide as a principal component, to at least one of a first bonding portion and a second bonding portion; a pressing unit configured to apply pressure to the first bonding portion and the second bonding portion so as to sandwich the solution between the first bonding portion and the second bonding portion, and in a direction in which a distance between the first bonding portion and the second bonding portion is reduced; and a heating unit configured to heat the first bonding portion and the second bonding portion, wherein the first bonding portion and the second bonding portion are bonded by the pressure applied by the pressing unit and the heat from the heating unit.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing a schematic configuration of a metal bonding apparatus according to an embodiment 1;

FIG. 2 is an enlarged schematic diagram showing a part in the vicinity of a stage of the metal bonding apparatus according to the embodiment 1;

FIGS. 3A through 3C are schematic diagrams for describing the operation of the metal bonding apparatus;

FIGS. 4A and 4B are schematic diagrams for describing the operation of the metal bonding apparatus;

FIGS. 5A through 5C are schematic diagrams for describing the operation of a metal bonding apparatus according to a modification 1;

FIGS. 6A through 6C are schematic diagrams for describing the operation of a metal bonding apparatus according to a modification 2;

FIGS. 7A through 7C are schematic diagrams for describing the operation of a metal bonding apparatus according to a modification 3;

FIG. 8 is a schematic diagram for describing the operation of a metal bonding apparatus according to a modification 4;

FIGS. 9A through 9C are schematic diagrams for describing the operation of a metal bonding apparatus according to a modification 5;

FIGS. 10A through 10D are schematic diagrams for describing the operation of a metal bonding apparatus according to a modification 6; and

FIG. 11 is a perspective view showing a schematic configuration of a metal bonding apparatus according to an embodiment 2.

### DETAILED DESCRIPTION OF THE INVENTION

The invention will now be described by reference to the preferred embodiments. This does not intend to limit the scope of the present invention, but to exemplify the invention.

Description will be made below regarding an embodiment of the present invention with reference to the drawings. It should be noted that, in all the drawings, the same components are denoted by the same reference symbols, and redundant description will be omitted. First, before specific description of the embodiment, description will be made regarding the basic knowledge for the present invention. With a conventional method in which a copper member is bonded to another copper member using conventional Sn-based solder, a Cu—Sn alloy occurs at a bonded interface between each copper layer and the adjacent solder layer. Such a Cu—Sn alloy has relatively large electric resistance, and poor ductility, leading to a problem of poor electrical characteristics and/or a problem of poor connection reliability at such a bonded portion. With a method in which the bonding faces are bonded to each other by applying pressure while heating the bonding faces at a high temperature, in some cases, such an arrangement leads to a problem of damage of a wiring substrate or a semiconductor chip due to the application of heat or the application of pressure. With a method in which the bonding faces are activated in a vacuum so as to bond the bonding faces to each other, such an arrangement requires large-scale equipment such as a vacuum apparatus, leading to an unavoidable increase in costs.

### Embodiment 1

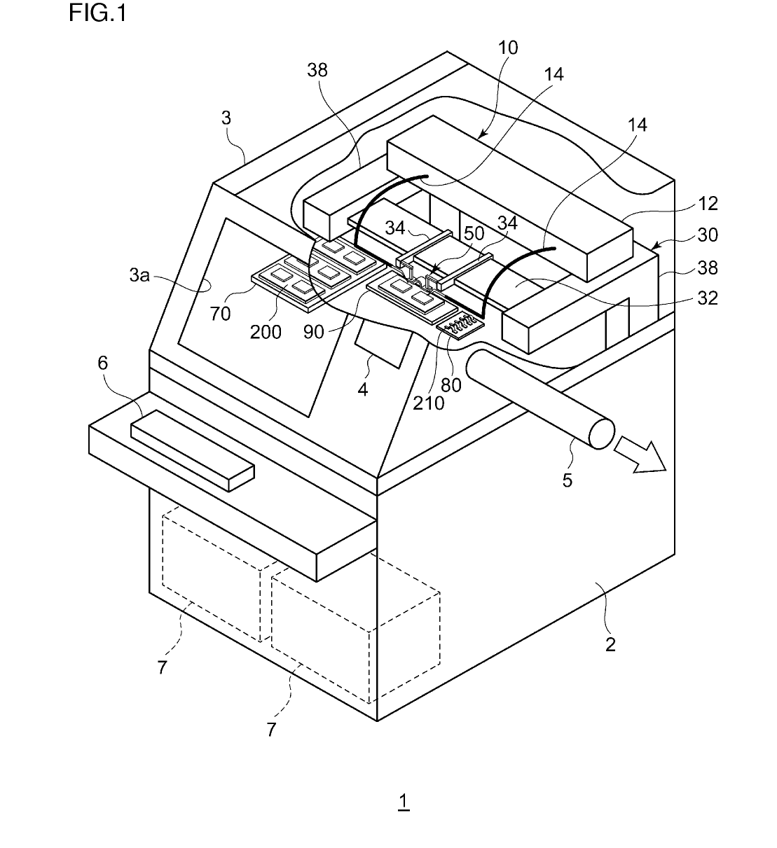

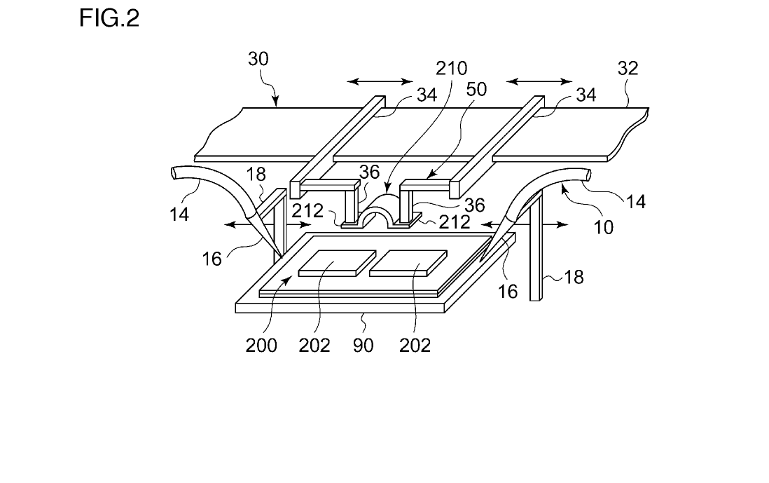

FIG. 1 is a perspective view showing a schematic configuration of a metal bonding apparatus according to an embodiment 1. FIG. 2 is an enlarged schematic diagram showing a part in the vicinity of a stage of the metal bonding apparatus according to the embodiment 1. It should be noted that, in FIG. 1, in order to show an internal configuration of the metal bonding apparatus, a part of the casing of a metal bonding apparatus is not shown.

A metal bonding apparatus 1 according to the present embodiment includes a casing 2 and a cover 3, and a solution supply unit 10, a pressing unit 30, and a heating unit 50, which are configured as principal components housed in a housing space defined by the casing 2 and the cover 3. The cover 3 includes a window 3a which allows the housing space to be monitored, a monitor 4 configured to display various kinds of setting conditions and the states of the metal bonding apparatus 1 such as a solution supply amount, pressure, temperature, etc., and an exhaust duct 5 configured to discharge gas that fills the housing space. The casing 2 includes an operating unit 6 which allows the user to input an instruction such as operation setting for the metal bonding apparatus 1, an instruction to start/stop the operation, and so forth. Furthermore, a control unit 7 is housed in the housing space, which enables various kinds of control operations to be executed for the metal bonding apparatus 1.

Furthermore, in the housing space of the metal bonding apparatus 1 according to the present embodiment, the metal bonding apparatus 1 includes a first member supply unit configured to store a first member 200 having a first bonding portion 202, and a second member supply unit 80 configured to store a second member 210 having a second bonding portion 212. The bonding target to be bonded by means of the metal bonding apparatus 1 is a pair of the first bonding portion 202 of the first member 200 and the second bonding portion 212 of the second member 210. Moreover, in the housing space, the metal bonding apparatus 1 includes a stage 90 on which pressure and heat are to be applied to the first bonding portion 202 and the second bonding portion 212.

The first member supply unit 70, the stage 90, and the second member supply unit 80 are arranged in this order. Furthermore, an arm rail 32 is provided such that it extends along the axis along which the first member supply unit 70, the stage 90, and the second member supply unit 80 are arranged. The arm rail 32 includes two slidable arms 34. The two arms 34 each include a member holding unit 36 (chuck) at one of their ends. Each member holding unit 36 is configured such that its end faces the lower side of the apparatus. The member holding unit 36 includes, at its end portion, a vacuum coupling opening connected to a vacuum pump (both units are not shown). By driving the vacuum pump in a state in which the end portion of the member holding unit 36 is in contact with a member to be held, such an arrangement allows the member holding unit 36 to hold the member. Furthermore, a heater is built into the member holding unit 36, which allows the member thus held to be heated. Thus, with the metal bonding apparatus 1 according to the present embodiment, the member holding unit 36 itself functions as the heating unit 50. It should be noted that the order in which the first member supply unit 70, the second member supply unit 80, and the stage 90 are arranged is not restricted in particular. Also, such a heater may be provided as an external heater that is separate from the member holding unit 36.

The arm rail 32 is arranged such that it does not overlap the first member supply unit 70, the second member supply unit 80, and the stage 90, when the metal bonding apparatus 1 is viewed from above (in plan view). The arms 34 are extended from the arm rail 32 toward an area in which the first member supply unit 70, the second member supply unit 80, and the stage 90 are arranged. The member holding unit 36 connected to the end portion of the arm 34 is arranged such that it overlaps the stage 90 in a plan view in a state in which the arm 34 is positioned at approximately the center of the arm rail 32. By sliding the arm 34 along the arm rail 32, such an arrangement is capable of moving the member holding unit 36 from a position above the stage 90 to a position above the first member supply unit 70 or otherwise the second member supply unit 80. It should be noted that the two arms 34 are configured to be slidable independently of each other along the arm rail 32.

Both ends of the arm rail 32 are respectively connected to rail support units 38. Each rail support unit 38 is configured in an approximately L shape as viewed from the side of the apparatus. The rail support unit 38 is arranged such that one of its ends is fixed to the end portion of the arm rail 32, and the other of its ends is positioned below on the rear side of the apparatus relative to the arm rail 32. The rail support unit 38 is arranged such that the aforementioned other end is connected to a driving mechanism (not shown) housed within the casing 2, which allows the rail support units 38 to be moved along the vertical direction of the apparatus. By moving the positions of the rail support units 38 along the vertical direction of the apparatus, such an arrangement is capable of moving the arm rail 32, the arms 34, and the member holding units 36 along the vertical direction of the apparatus according to the displacement of the rail support units 38. Thus, such an arrangement allows the end portion of each member holding unit 36 to approach and retract from the first member supply unit 70, the second member supply unit 80, or otherwise the stage 90.

With such a metal bonding apparatus 1, the arm 34 is slid toward the first member supply unit 70 side, and the rail support units 38 are moved downward relative to the apparatus, so as to move the member holding unit 36 such that its end approaches the first member supply unit 70, and the first member 200 stored in the first member supply unit 70 is held by means of vacuum contact. Subsequently, the rail support units 38 are moved upward relative to the apparatus such that the end portion of the member holding unit 36 retracts from the first member supply unit 70, and the arm 34 is slid toward the stage 90 side. Subsequently, the metal bonding apparatus 1 instructs the rail support units 38 to move downward relative to the apparatus such that the end portion of the member holding unit 36 approaches the stage 90, so as to mount, on the stage 90, the first member 200 held by the member holding unit 36 by means of vacuum contact. In the same way, such an arrangement is capable of transferring the second member 210 from the second member supply unit 80 to the stage 90. Thus, with the present embodiment, the arm rail 32, the arms 34, the member holding unit 36, and the rail support units 38 compose a first transfer unit configured to transfer the first member 200 having the first bonding portion 202 to the stage 90, and a second transfer unit configured to transfer the second member 210 having the second bonding portion 212 to the stage 90.

Furthermore, by moving the positions of the rail support units 38 downward relative to the apparatus in a state in which the first member 200 is mounted on the stage 90 and the second member 210 is held by the member holding unit 36, such an arrangement is capable of applying pressure to the first bonding portion 202 and the second bonding portion 212 in a direction in which the distance between the first bonding portion 202 of the first member 200 and the second bonding portion 212 of the second member 210 is reduced. Thus, with the present embodiment, the arm rail 32, the arms 34, the member holding units 36, and the rail support units 38 compose the pressing unit 30.

A solution tank 12 is fixedly mounted on the rail support units 38. Two solution supply tubes 14 are arranged such that one end of each solution supply tube 14 is connected to the solution tank 12. Furthermore, the two solution supply tubes 14 are arranged such that the other end of each solution supply tube 14 extends up to a position in the vicinity of the end portion of the member holding unit 36. A nozzle 16 is provided to the aforementioned other end of each solution supply tube 14. With the present embodiment, each nozzle 16 has a dropper structure. Each nozzle 16 is connected to the arm 18 connected to the driving mechanism (not shown) housed in the casing 2. Each arm 18 allows the nozzle 16 to approach and retract from the bonding region in which the first bonding portion 202 and the second bonding portion 212 are to be bonded. A solution retained in the solution tank 12 is dropped from the nozzle 16 via the solution supply tube 14 in a state in which the nozzle 16 is positioned in the vicinity of the bonding region on the stage in which the first bonding portion 202 and the second bonding portion 212 are to be bonded. With such an arrangement, the solution is supplied to at least one of the first bonding portion 202 or the second bonding portion 212. Thus, with the present embodiment, the solution tank 12, the solution supply tubes 14, the nozzles 16, and the arms 18 compose the solution supply unit 10.

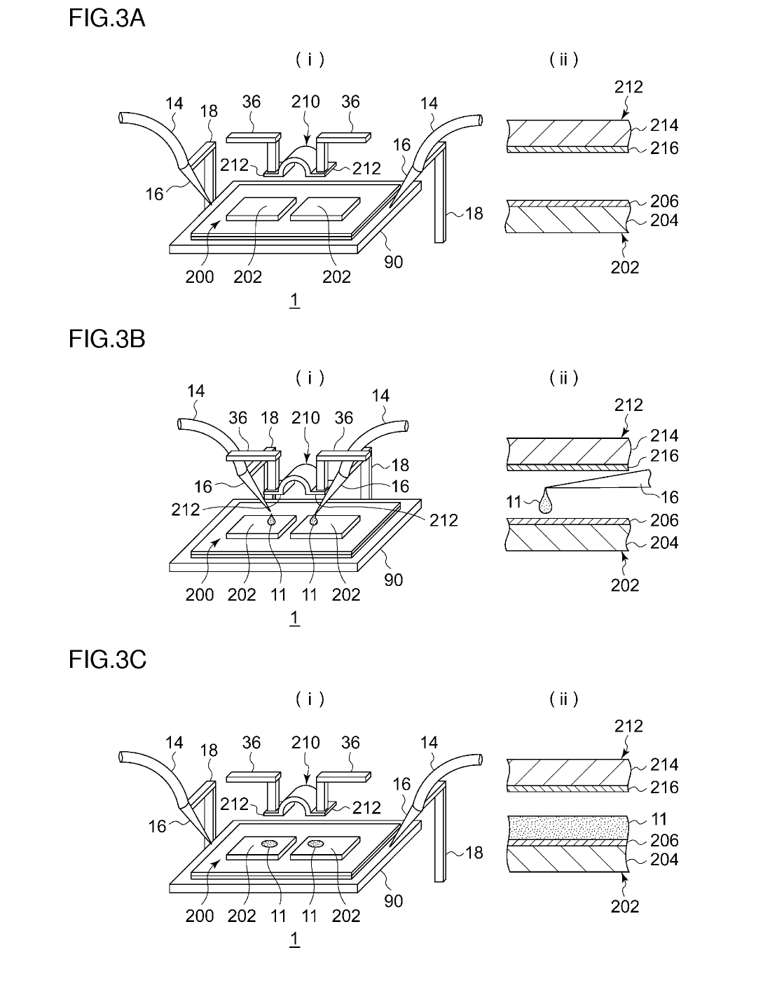

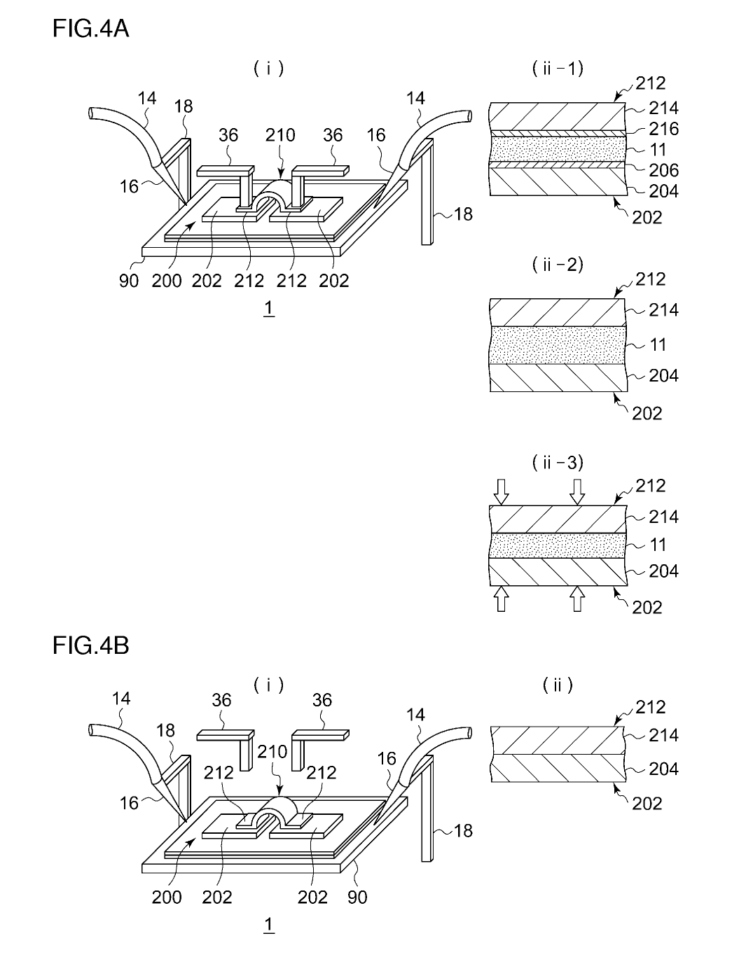

Next, description will be made regarding the operation of the metal bonding apparatus 1 according to the present embodiment. FIGS. 3A through 3C, and FIGS. 4A and 4B are schematic diagrams each showing the operation of the metal bonding apparatus. In each drawing, (i) shows an enlarged view showing a part in the vicinity of the stage, and (ii) (or (ii-1) through (ii-3) in FIG. 4A) shows a schematic diagram which shows the state of the first bonding portion and the second bonding portion. It should be noted that, in FIGS. 3A through 3C, and FIGS. 4A and 4B, the arm rail 32, the arms 34, and so forth, are not shown. It should be noted that a heater, which functions as a solution heating unit which allows the solution 11 to be heated beforehand, may be mounted on the solution tank 12. Such an arrangement allows the solution 11 to be evaporated in a short period of time in the bonding step described later, thereby reducing the overall period of time required for the bonding process.

As shown in FIG. 3A, the metal bonding apparatus 1 transfers the first member 200 having the first bonding portion 202 from the first member supply unit 70, and mounts the first member 200 on the stage 90. Furthermore, the metal bonding apparatus 1 instructs the member holding unit 36 to hold the second member 210 having the second bonding portion 212, and to arrange the second member 210 above the first member 200. The first bonding portion 202 includes a first base portion 204 formed of a metal with copper as the principal component, and a first coating portion 206 configured to coat the surface of the bonding face side of the first base portion 204. Furthermore, the second bonding portion 212 includes a second base portion 214 formed of a metal with copper as the principal component, and a second coating portion 216 configured to coat the surface of the bonding face side of the second base portion 214. The first coating portion 206 and the second coating portion 216 are each formed of an oxide material with copper oxide as a principal component. Here, “with copper as a principal component” and “with copper oxide as a principal component” mean that the material contains copper or copper oxide with a concentration that is greater than 50%.

Provided that the first base portion 204 and the second base portion 214 are formed of copper-based metal, the forms of the first base portion 204 and the second base portion 214 are not restricted in particular. For example, the first base portion 204 and the second base portion 214 may each be configured as a deposited layer formed of copper on a substrate such as a silicon substrate using a sputtering method or the like. Also, the first base portion 204 and the second base portion 214 may each be configured as an external terminal portion of a wiring layer formed by patterning a copper sheet such as a copper foil. Specifically, the first coating portion 206 and the second coating portion 216 are each configured as a thin film formed of Cu₂O, CuO, or the like, and each having a thickness of 10 nm, for example. The first coating portion 206 and the second coating portion 216 may each be configured as an artificial coating film or a natural coating film. With the present embodiment, the first coating portion 206 and the second coating portion 216 are each configured as a natural oxide film, which is formed by oxidation of copper in the atmosphere.

Next, as shown in FIG. 3B, the metal bonding apparatus 1 moves the nozzle 16 by means of the arm 18 such that the end of the nozzle 16 is positioned between the first bonding portion 202 and the second bonding portion 212. Subsequently, the solution 11 is dropped from the nozzle 16 onto the surface of the first coating portion 206. As a result, as shown in FIG. 3C, the surface of the first coating portion 206 is coated with the solution 11. Thus, the solution 11, into which the oxide with copper oxide as a principal component can be eluted or dissolved, is supplied to the space between the first coating portion 206 and the second coating portion 216. Subsequently, the metal bonding apparatus 1 shifts the arm 18 so as to retract the nozzle 16 from the space between the first bonding portion 202 and the second bonding portion 212. It should be noted that, with the present embodiment, ammonia water is employed as the solution 11. The solution 11 may be applied to the second bonding portion 212 side.

Next, as shown in FIG. 4A, the metal bonding apparatus 1 moves the member holding unit 36 such that it approaches the stage 90 until the second coating portion 216 of the second bonding portion 212 comes in contact with the solution 11 applied to the first coating portion 206 of the first bonding portion 202 (see (ii-1) in FIG. 4A). After the first coating portion 206 and the second coating portion 216 come in contact with the solution 11, the copper oxide that forms the first coating portion 206 and the copper oxide that forms the second coating portion 216 are eluted into the solution 11 (see (ii-2) in FIG. 4A). As a result, copper that forms the first base portion 204 and copper that forms the second base portion 214 are respectively exposed as the outermost face (exposed face on the bonding face side) of the first bonding portion 202 and the outermost face (exposed face on the bonding face side) of the second bonding portion 212. In the solution 11, an ammonia ion that functions as a ligand and a copper ion form a copper complex. With the present embodiment, such a copper complex is considered to be configured as a thermo-degradable tetraamine copper complex ion represented by [Cu(NH₃₄]²⁺. It should be noted that ammonia water is inactive with respect to copper. Thus, copper which is a component of the first base portion 204, and copper which is a component of the second base portion 214, do not react with the ammonia water and remains as a component of the respective portions.

The metal bonding apparatus 1 further moves the member holding unit 36 such that it approaches the stage 90, so as to apply pressure to the first bonding portion 202 and the second bonding portion 212 such that the distance between them is reduced (see (ii-3) in FIG. 4A). In the pressure applying step, pressure of 1 MPa is applied, for example.

In such a state in which the first bonding portion 202 and the second bonding portion 212 are pressed in contact with each other, the metal bonding apparatus 1 heats the second bonding portion 212, the solution 11, and the first bonding portion 202 at a relatively low temperature of 200° C. to 300° C. With the present embodiment, the heating provides evaporation of water. Furthermore, the heating provides thermal decomposition of the thermo-degradable tetraamine copper complex ion, thereby providing evaporation of the ammonia component. This gradually increases the concentration of copper contained in the solution 11. Furthermore, pressing by means of the pressing unit 30 gradually reduces the distance between the outermost face of the first bonding portion 202 and the outermost face of the second bonding portion 212.

Next, as shown in FIG. 4B, after the outermost face of the first bonding portion 202 approaches the outermost face of the second bonding portion 212, copper exposed on the surface of the first bonding portion 202 and copper exposed on the surface of the second bonding portion 212 are solid-phase diffused. This bonds the first bonding portion 202 and the second bonding portion 212 to each other. After the completion of the bonding, the metal bonding apparatus 1 stops the heating provided by the member holding unit 36, and retracts the member holding unit 36 from the stage 90 so as to end the pressing. By executing the aforementioned steps, the bonding of the first bonding portion 202 and the second bonding portion 212 is completed. It should be noted that the time of a period from the start of heating up to the stop of heating is 30 seconds, for example. Description has been made in the present embodiment regarding an arrangement in which, after pressure is applied to the first bonding portion 202 and the second bonding portion 212, the first bonding portion 202 and the second bonding portion 212 are heated. However, the order of pressing and heating is not restricted in particular. Also, the heating may be performed before pressure is applied. Also, the heating and the pressing may be performed at the same time. For example, the second bonding portion 212 heated beforehand may be pressed into contact with the first bond portion 202 to which the solution 11 is applied.

With the metal bonding apparatus 1 described above, the first coating portion 206 and the second coating portion 216 are eluted into the solution 11, thereby exposing copper on the bonding face of each of the first bonding portion 202 and the second bonding portion 212. In other words, the bonding face of the first bonding portion 202 and the bonding face of the second bonding portion 212 are activated. After the bonding face of the first bonding portion 202 and the bonding face of the second bonding portion 212 are activated, bonding is performed by means of solid-phase diffusion of the copper thus exposed. Thus, such an arrangement provides copper-copper bonding at a relatively low temperature. In addition, such an arrangement provides copper-copper bonding at a relatively low pressure. Thus, such an arrangement reduces the risk of damage that can occur at the first bonding portion 202 and the second bonding portion 212. Furthermore, such an arrangement suppresses the occurrence of voids or byproducts between the respective bonding faces of the first bonding portion 202 and the second bonding portion 212, thereby providing improved reliability of connection between the first bonding portion 202 and the second bonding portion 212.

Furthermore, the solution 11 is dropped from the nozzle 16 that is moved such that it approaches the bonding region between the first bonding portion 202 and the second bonding portion 212. Thus, such an arrangement is capable of locally supplying an appropriate amount of the solution 11. Thus, such an arrangement prevents the solution 11 from scattering, thereby avoiding a problem of corrosion of the first member 200 and the second member 210. Furthermore, such an arrangement is capable of preventing an increase in the bonding time due to an excess supply of the solution 11.

### [Solution Used for Metal Bonding]

With the metal bonding apparatus 1 according to the aforementioned embodiment 1, ammonia water is used as the solution 11 to be used for metal bonding. However, the present invention is not restricted to such an arrangement. Rather, a desired solution may be employed provided that the solution contains a ligand that can form a complex with copper. Examples of such a solution include a carboxylic acid aqueous solution.

Examples of carboxylic acids used to prepare such a carboxylic acid aqueous solution include: monocarboxylic acid such as acetic acid, and the like; dicarboxylic acid such as oxalic acid, malonic acid, succinic acid, glutaric acid, phthalic acid, maleic acid, and the like; and oxycarboxylic acid such as tartaric acid, citric acid, lactic acid, salicylic acid, and the like.

With such an arrangement, such a carboxylic acid aqueous solution preferably contains carboxylic acid which is able to function as a multidentate ligand. With such a carboxylic acid aqueous solution containing carboxylic acid which is able to function as a multidentate ligand, such a carboxylic acid provides at least two coordinate bonds that bond a single copper ion, and forms a chelate, thereby generating a copper complex having markedly improved stability. As a result, such an arrangement is capable of reducing the temperature required for the bonding. It should be noted that the fact that tartaric acid forms a chelate is described in “The Iwanami Dictionary of Physics and Chemistry”, 4th ed., p. 593 (Iwanami Shoten). Also, the fact that tartaric acid, oxalic acid, etc., each forms a chelate is described in “Inorganic chemistry”, Vol. 2, p. 666, written by R. B. Heslop, K. Jones, translated by Yoshihiko Saito. Here, chelation represents a reaction in which a multidentate ligand forms a ring, thereby generating a complex having markedly improved stability.

### [Bonding Test Using Carboxylic Acid Aqueous Solution]

A metal bonding test was performed using an acetic acid solution (acetic acid concentration of 10% by weight) and an oxalic acid solution (oxalic acid concentration of 10% by weight). It should be noted that bonding was performed at a pressure of 1 MPa.

With the bonding using an acetic acid solution containing monocarboxylic acid, when the bonding was performed at a bonding temperature of 150° C., such an arrangement exhibited a shear stress of 25 MPa or more, i.e., provided a sufficient bonding strength. However, when the bonding was performed at a bonding temperature of 125° C., such an arrangement was not capable of providing such sufficient bonding strength.

In contrast, with the bonding using an oxalic acid solution containing dicarboxylic acid, such an arrangement exhibited a shear stress of 25 MPa or more, i.e., provided sufficient bonding strength even if the bonding was performed under a low temperature condition of 125° C. However, when the bonding was performed at a further reduced temperature of 100° C., such an arrangement was not capable of providing a sufficient bonding strength.

As a result of the aforementioned bonding test, it has been confirmed that, by employing an oxalic acid solution that forms a chelate with a copper ion, such an arrangement provides bonding even if the bonding temperature is reduced to on the order of 125° C. It is difficult for conventional techniques to provide metal bonding under such a low-temperature condition. Thus, it can be said that metal bonding under such a low-temperature condition is one of the features of the present metal bonding technique. The present metal bonding technique is expected to be widely applied in the future in various kinds of fields, in addition to electronic component bonding.

Various kinds of modifications as described below will be made regarding the metal bonding apparatus 1 according to the aforementioned embodiment 1.

### [Modification 1]

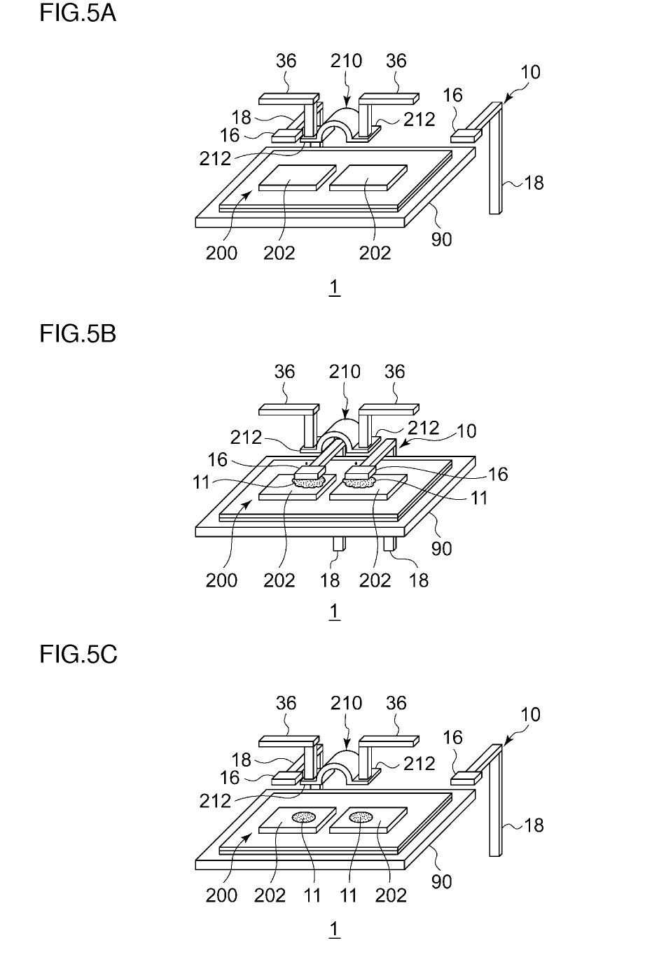

With the metal bonding apparatus 1 according to a modification 1, the solution supply unit 10 includes a spray nozzle configured to spray the solution 11 onto at least one of the first bonding portion 202 or the second bonding portion 212. That is to say, with the present modification, the nozzle 16 is configured as a spray nozzle. Description will be made below regarding the metal bonding apparatus 1 according to the modification 1 with reference to FIGS. 5A through 5C.

FIGS. 5A through 5C are schematic diagrams for describing the operation of the metal bonding apparatus according to the modification 1. It should be noted that FIGS. 5A through 5C each show a schematic configuration of a part in the vicinity of the stage. The arm rail 32, the arms 34, the solution supply tubes 14, and so forth, are not shown in these drawings.

As shown in FIG. 5A, the metal bonding apparatus 1 mounts, on the stage 90, the first member 200 having the first bonding portion 202. Furthermore, the metal bonding apparatus 1 instructs the member holding unit 36 to hold the second member 210 having the second bonding portion 212, and arranges the second member 210 above the first member 200.

Next, as shown in FIG. 5B, the metal bonding apparatus 1 instructs the arm 18 to move the nozzle 16 such that the nozzle 16 is positioned between the first bonding portion 202 and the second bonding portion 212. Subsequently, the metal bonding apparatus 1 sprays the solution 11 onto the surface of the first bonding portion 202 via the nozzle 16. As a result, as shown in FIG. 5C, the surface of the first bonding portion 202 is coated with the solution 11. Subsequently, the metal bonding apparatus 1 retracts the nozzle 16 from a space between the first bonding portion 202 and the second bonding portion 212. It should be noted that the solution 11 may be applied to the second bonding portion 212 side. The subsequent operation is the same as that described with reference to FIGS. 4A and 4B, and accordingly, description thereof will be omitted.

With the present embodiment, the nozzle 16 is configured as a spray nozzle. Thus, such an arrangement allows the surface of the first coating portion 206 or the surface of the second coating portion 216 to be coated with the solution 11 with high uniformity. Furthermore, such an arrangement suppresses excess coating of the surface of the coating portion with the solution 11.

### [Modification 2]

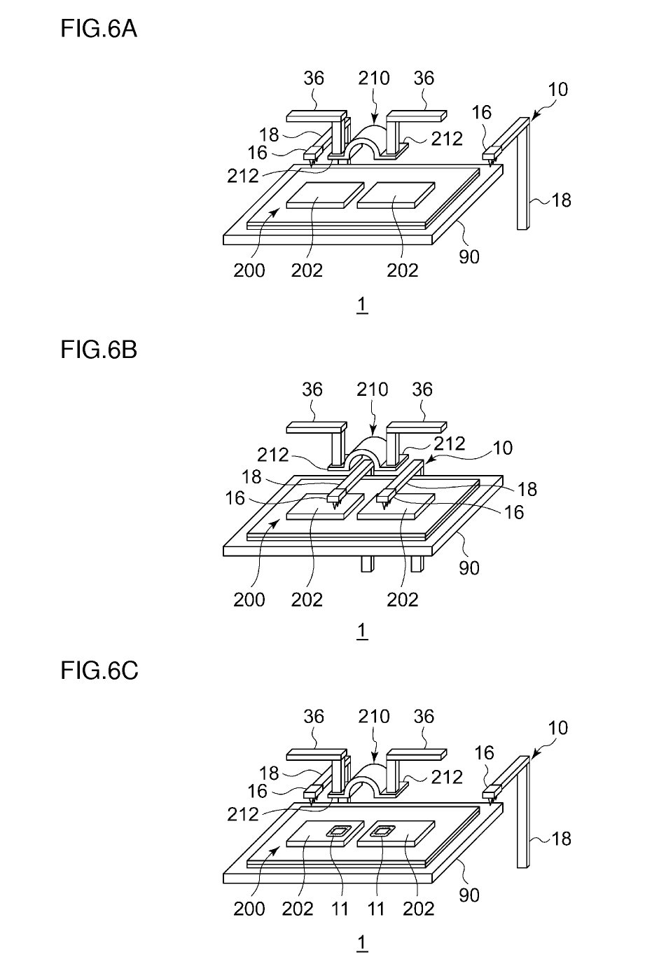

The metal bonding apparatus 1 according to a modification 2 includes an inkjet nozzle configured to discharge the solution 11 onto at least one of the first bonding portion 202 or the second bonding portion 212. That is to say, with the present modification, the nozzle 16 is configured as an inkjet nozzle. Description will be made below regarding the metal bonding apparatus 1 according to the modification 2 with reference to FIGS. 6A through 6C.

FIGS. 6A through 6C are schematic diagrams for describing the operation of the metal bonding apparatus according to the modification 2. It should be noted that FIGS. 6A through 6C each show a schematic configuration of a part in the vicinity of the stage. The arm rail 32, the arms 34, the solution supply tubes 14, and so forth, are not shown in these drawings.

As shown in FIG. 6A, the metal bonding apparatus 1 mounts, on the stage 90, the first member 200 having the first bonding portion 202. Furthermore, the metal bonding apparatus 1 instructs the member holding unit 36 to hold the second member 210 having the second bonding portion 212, and arranges the second member 210 above the first member 200.

Next, as shown in FIG. 6B, the metal bonding apparatus 1 instructs the arm 18 to move the nozzle 16 such that the nozzle 16 is positioned between the first bonding portion 202 and the second bonding portion 212. Subsequently, the metal bonding apparatus 1 discharges the solution 11 onto the surface of the first bonding portion 202 via the nozzle 16. The metal bonding apparatus 1 discharges the solution 11 onto the surface of the first bonding portion 202 while the nozzle 16 is scanned over the surface such that a region set beforehand is coated with the solution 11. The information regarding the region to be coated with the solution 11 is input beforehand to the control unit 7 via the operating unit 6, for example. As a result, as shown in FIG. 6C, the surface of the first bonding portion 202 is coated with the solution 11. Subsequently, the metal bonding apparatus 1 retracts the nozzle 16 from a space between the first bonding portion 202 and the second bonding portion 212. It should be noted that the solution 11 may be applied to the second bonding portion 212 side. The subsequent operation is the same as that described with reference to FIGS. 4A and 4B, and accordingly, description thereof will be omitted.

With the present modification, the nozzle 16 is configured as an inkjet nozzle. Thus, such an arrangement is capable of providing a solution-coated region having various kinds of shapes according to the shape of the first bonding portion 202 or the shape of the second bonding portion 212.

### [Modification 3]

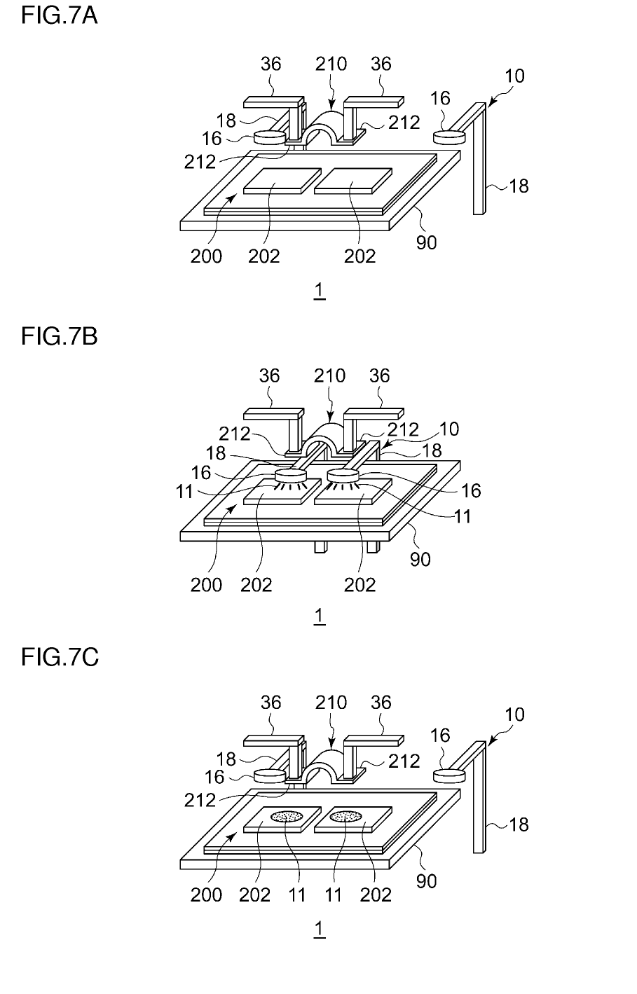

The metal bonding apparatus 1 according to a modification 3 includes a shower head configured to disperse the solution 11 onto at least one of the first bonding portion 202 or the second bonding portion 212. That is to say, with the present modification, the nozzle 16 is configured as a shower head. Description will be made below regarding the metal bonding apparatus 1 according to the modification 3 with reference to FIGS. 7A through 7C.

FIGS. 7A through 7C are schematic diagrams for describing the operation of the metal bonding apparatus according to the modification 3. It should be noted that

FIGS. 7A through 7C each show a schematic configuration of a part in the vicinity of the stage. The arm rail 32, the arms 34, the solution supply tubes 14, and so forth, are not shown in these drawings.

As shown in FIG. 7A, the metal bonding apparatus 1 mounts, on the stage 90, the first member 200 having the first bonding portion 202. Furthermore, the metal bonding apparatus 1 instructs the member holding unit 36 to hold the second member 210 having the second bonding portion 212, and arranges the second member 210 above the first member 200.

Next, as shown in FIG. 7B, the metal bonding apparatus 1 instructs the arm 18 to move the nozzle 16 such that the nozzle 16 is positioned between the first bonding portion 202 and the second bonding portion 212. Subsequently, the metal bonding apparatus 1 discharges the solution 11 onto the surface of the first bonding portion 202 via the nozzle 16. As a result, as shown in FIG. 7C, the surface of the first bonding portion 202 is coated with the solution 11. Subsequently, the metal bonding apparatus 1 retracts the nozzle 16 from a space between the first bonding portion 202 and the second bonding portion 212. It should be noted that the solution 11 may be applied to the second bonding portion 212 side. The subsequent operation is the same as that described with reference to FIGS. 4A and 4B, and accordingly, description thereof will be omitted.

With the present modification, the nozzle 16 is configured as a shower head. Thus, such an arrangement is preferably employed in a case in which the region to be coated with the solution 11 is relatively large.

### [Modification 4]

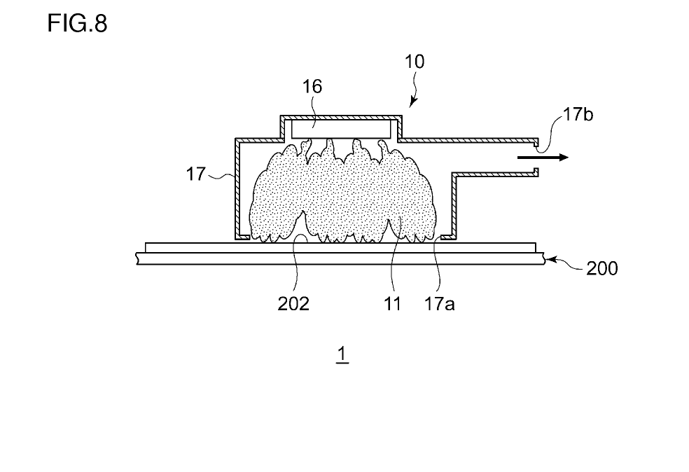

The metal bonding apparatus 1 according to a modification 4 includes a partition that encloses at least one of the region of the first bonding portion 202 or the region of the second bonding portion 212 onto which the solution 11 is to be supplied, and is configured to supply the solution 11 to the region enclosed by the partition. Description will be made below regarding the metal bonding apparatus 1 according to the modification 4 with reference to FIG. 8.

FIG. 8 is a schematic diagram for describing the operation of the metal bonding apparatus according to the modification 4. It should be noted that FIG. 8 shows the nozzle and a part in the vicinity of the first bonding portion. The nozzle 16 shown in FIG. 8 is configured as a spray nozzle.

As shown in FIG. 8, the metal bonding apparatus 1 includes a partition (clamper) 17 that encloses the circumference of the nozzle 16. The partition 17 is configured approximately in the form of a casing, and is configured such that the nozzle 16 is fixed to the upper side of the inner wall. Furthermore, an opening 17a is formed on the lower face, which allows the solution 11, which was sprayed via the nozzle 16, to be discharged to the exterior. Moreover, an exhaust outlet 17b is provided to the side wall. The opening 17a has the same shape as that of the region to be coated with the solution 11. When the nozzle 16 is moved such that it approaches the first bonding portion 202, the partition 17 approaches the first bonding portion 202, in addition to the nozzle 16, whereby the lower end of the partition 17 comes in contact with the first bonding portion 202. In this state, the region to which the solution 11 is to be supplied is enclosed by the partition 17. Thus, when the solution 11 is sprayed from the nozzle 16, only the region enclosed by the partition 17, i.e., the region that overlays the opening 17a of the partition 17, is coated with the solution 11. It should be noted that the nozzle 16 is not restricted to such a spray nozzle. Also, the nozzle 16 may be configured as a dropper, a shower head, or the like.

With the present modification, the region to which the solution 11 is to be supplied is enclosed by the partition 17. Thus, only the region to be coated with the solution 11, i.e., only the bonding portion, is coated with the solution 11. That is to say, such an arrangement is capable of preventing the solution 11 from spattering to other regions.

### [Modification 5]

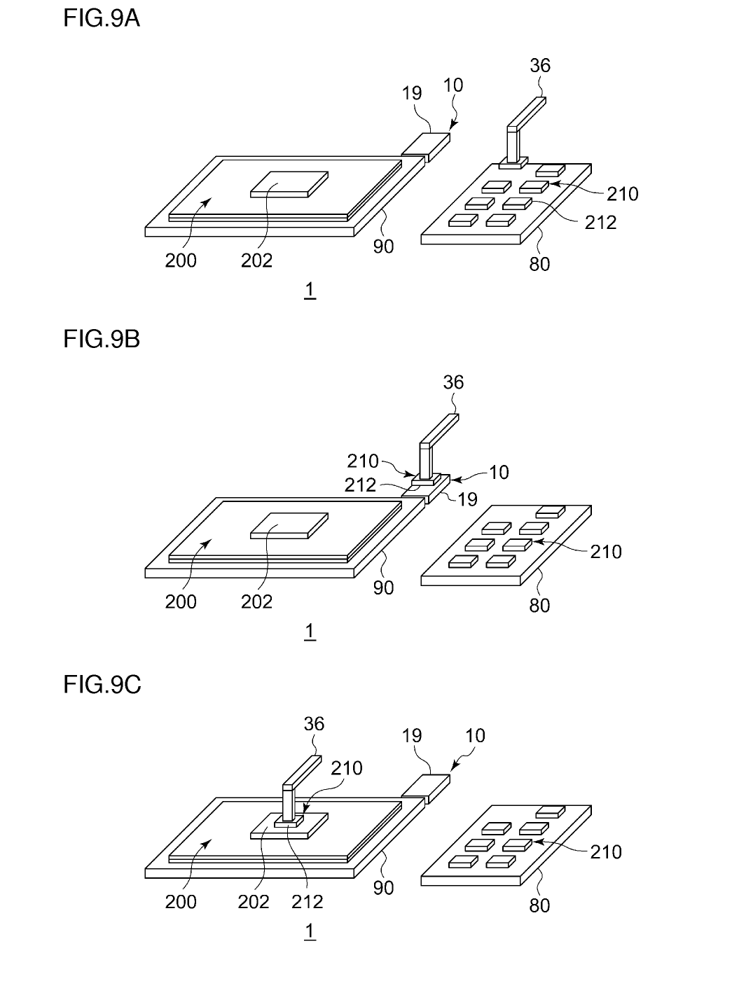

With the metal bonding apparatus 1 according to a modification 5, the solution supply unit 10 includes a container for the solution 11. The metal bonding apparatus 1 is configured to bring at least one of the first bonding portion 202 or the second bonding portion 212 into contact with the solution 11 stored in the container. Description will be made regarding the metal bonding apparatus 1 according to the modification 5 with reference to FIGS. 9A through 9C. FIGS. 9A through 9C are schematic diagrams for describing the operation of the metal bonding apparatus 1 according to the modification 5. It should be noted that, in FIGS. 9A through 9C, the arm 18, the arm rail 32, the arm 34, and so forth, are not shown.

As shown in FIG. 9A, the metal bonding apparatus 1 includes a container 19 configured to store the solution 11. With the present modification, the container 19 is connected to the solution supply tube 14 (see FIG. 1), such that the solution 11 stored in the solution tank 12 (see FIG. 1) is supplied to the container 19 via the solution supply tube 14. The container 19 may be configured as a vessel (vat), for example. Also, the container 19 may be configured as a porous body such as sponge or the like impregnated with the solution 11. The metal bonding apparatus 1 mounts the first member 200 having the first bonding portion 202 on the stage 90. Furthermore, the metal bonding apparatus 1 instructs the member holding unit 36 to move to a position above the second member supply unit 80, and to hold the second member 210 having the second bonding portion 212 by means of vacuum contact.

Next, as shown in FIG. 9B, the metal bonding apparatus 1 instructs the member holding unit 36 to move to a position above the container 19, and to move downward toward the lower side of the apparatus, so as to immerse the second bonding portion 212 of the second member 210 held by the end portion of the member holding unit 36 in the container 19, thereby coating the second bonding portion 212 with the solution 11.

Next, as shown in FIG. 9C, the metal bonding apparatus 1 instructs the member holding unit 36 to move to a position above the stage 90. Subsequently, the metal bonding apparatus 1 instructs the member holding unit 36 to move such that it approaches the stage 90 until the solution 11 applied to the second bonding portion 212 comes in contact with the first bonding portion 202. The subsequent operation is the same as that shown in FIGS. 4A and 4B, and accordingly, description thereof will be omitted. It should be noted that the solution 11 may be applied to the first bonding portion 202 side. However, from among the first member 200 having the first bonding portion 202 and the second member 210 having the second bonding portion 212, the member for which the region that has the same level as that of its bonding portion has the smaller area is preferably selected as such a member to be brought into contact with the solution 11. Such an arrangement is capable of protecting the regions other than the bonding portion from being coated with the solution 11.

With the present modification, either the first bonding portion 202 or the second bonding portion 212 is immersed in the container storing the solution 11 so as to coat the bonding portion with the solution 11. Thus, such an arrangement allows the solution supply unit 10 to have a simple configuration.

### [Modification 6]

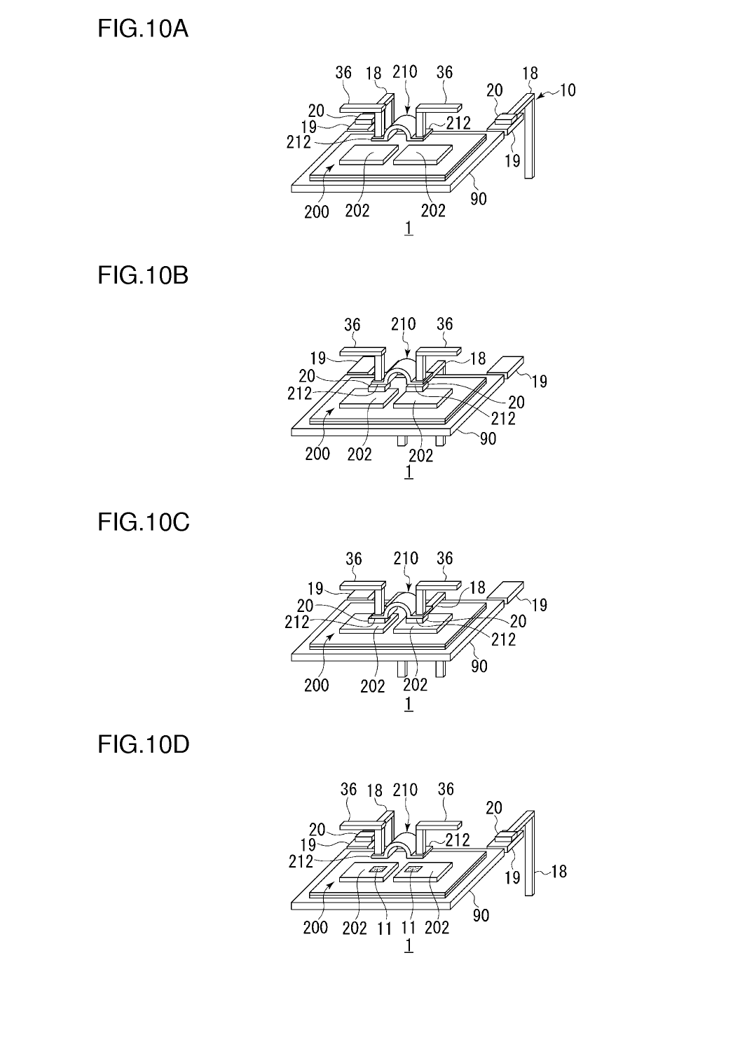

With the metal bonding apparatus 1 according to the modification 6, the solution bonding apparatus 10 includes a soft porous body which is to be impregnated with the solution 11. The metal bonding apparatus 1 is configured to press the porous body, with which the solution 11 is impregnated, into contact with at least one of the first bonding portion 202 or the second bonding portion 212. Description will be made below regarding the metal bonding apparatus 1 according to the modification 6 with reference to FIGS. 10A through 10D. FIGS. 10A through 10D are schematic diagrams for describing the operation of the metal bonding apparatus 1 according to the modification 6. It should be noted that FIGS. 10A through 10D each show a part in the vicinity of the stage, and the components such as the arm rail 32 and the arm 34 are not shown.

As shown in FIG. 10A, the metal bonding apparatus 1 includes a soft porous body 20 which is to be impregnated with the solution 11. Examples of such a porous body 20 include a sponge. The arm 18 is connected to the porous body 20. Furthermore, the metal bonding apparatus 1 includes a container 19 configured to store the solution 11. With the present modification, the container 19 is connected to the solution supply tube 14 (see FIG. 1), such that the solution 11 stored in the solution tank 12 (see FIG. 1) is supplied to the container 19 via the solution supply tube 14. The container 19 may be configured as a vessel (vat), for example. The metal bonding apparatus 1 is configured to immerse the porous body 20 in the container 19 so as to impregnate the porous body 20 with the solution 11 stored in the container 19. Furthermore, the metal bonding apparatus 1 mounts the first member 200 having the first bonding portion 202 on the stage 90. Moreover, the metal bonding apparatus 1 instructs the member holding unit 36 to hold the second member 210 having the second bonding portion 212, and to arrange the second member 210 thus held above the first member 200.

Next, as shown in FIG. 10B, the metal bonding apparatus 1 instructs the arm 18 to move the porous body 20 such that it is positioned between the first bonding portion 202 and the second bonding portion 212. Subsequently, as shown in FIG. 10C, the metal bonding apparatus 1 instructs the member holding unit 36 to approach the stage 90, such that the porous body 20 impregnated with the solution 11 is introduced between the first bonding portion 202 and the second bonding portion 212. Thus, the first bonding portion 202 and the second bonding portion are each coated with the solution 11.

Next, as shown in FIG. 10D, the metal bonding apparatus 1 retracts the member holding unit 36 from the stage 90, so as to return the porous body 20 to the container 19. The subsequent operation is the same as that shown in FIGS. 4A and 4B, and accordingly, description thereof will be omitted. It should be noted that the porous body 20 may be pressed into contact with the first bonding portion 202 or otherwise the second bonding portion 212, thereby coating the first bonding portion 202 side alone or otherwise the second bonding portion 212 side alone with the solution 11.

With the present modification, the porous body 20 impregnated with the solution 11 is introduced between the first bonding portion 202 and the second bonding portion 212 so as to coat them with the solution 11. Thus, such an arrangement allows the solution supply unit 10 to have a simple configuration.

### Embodiment 2

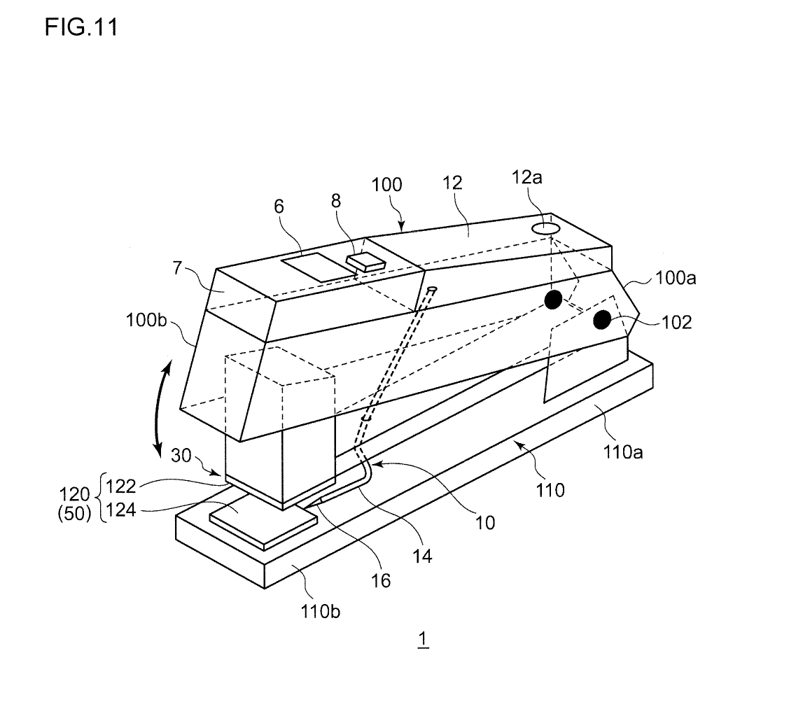

A metal bonding apparatus according to an embodiment 2 is configured as a handheld apparatus. Description will be made below regarding the metal bonding apparatus 1 according to the embodiment 2 with reference to FIG. 11. FIG. 11 is a perspective view showing a schematic configuration of the metal bonding apparatus according to the embodiment 2.

The metal bonding apparatus 1 according to the present embodiment includes a first arm 100 and a second arm 110. The second arm 110 is arranged such that one end 110a side thereof is rotatably connected to one end 100a side of the first arm 100. With the present embodiment, the one end 100a side of the first arm 100 and the one end 110a side of the second arm 110 are connected to each other by means of a movable unit 102 such as a hinge or the like such that they can be turned relative to one another. Thus, the first arm 100 and the second arm 110 can be operated such that the other end 100b side of the first arm 100 and the other end 110b side of the second arm 110 are moved relative to one another, i.e., such that they approach each other or otherwise move away from each other.

A base pair 120 is provided to the faces of the other end 100b side of the first arm 100 and the other end 110b side of the second arm 110 that face each other. The base pair 120 includes a first base 122 provided to the first arm 100 and a second base 124 provided to the second arm 110. In a state in which the first arm 100 and the second arm 110 are not operated, a space is defined by the base pair 120, which allows the first bonding portion 202 and the second bonding portion 212 to be inserted. By turning the first arm 100 and the second arm 110 relative to one another with the movable unit 102 as an axis such that the other end 100b side of the first arm 100 approaches the other end 110b side of the second arm 110, such an arrangement is capable of applying pressure to the first bonding portion 202 and the second bonding portion 212 inserted into the space between the first base 122 and the second base 124. Thus, with the metal bonding apparatus 1 according to the present embodiment, a pressing unit 30 comprises the first arm 100, the second arm 110, and the base pair 120.

The first base 122 and the second base 124 of the base pair 120 each include a heater. Thus, such an arrangement allows the first bonding portion 202 and the second bonding portion 212 thus inserted to be heated by means of the first base 122 and the second base 124. Thus, with the metal bonding apparatus 1 according to the present embodiment, the base pair 120 functions as a heating unit 50.

A solution tank 12 is provided to the face of the end 100a of the first arm 100 that is opposite to the second arm 110. A solution inlet 12a is provided to the solution tank 12, which allows the solution 11 to be supplied to the tank. Furthermore, a nozzle 16 is provided to the other end 100b side of the first arm 100. The nozzle 16 is configured to supply the solution 11 stored in the solution tank 12 to at least the first bonding portion 202 or the second bonding portion 212 inserted in the space between the first base 122 and the second base 124. The solution tank 12 and the nozzle 16 are connected to each other by means of a solution supply tube 14 provided within the first arm 100.

Furthermore, a control unit 7 is provided to the face of the first arm 100 that is opposite to the second arm 110 such that it is arranged adjacent to the solution tank 12. An operating unit 6 and a solution supply button 8 are provided to the top face of the control unit 7. The operating unit 6 may have a display function of displaying the setting temperature, the remaining amount of the solution, and so forth. That is to say, a monitor 4 may be built into the operating unit 6. By pressing the solution supply button 8, such an arrangement allows the solution 11 stored in the solution tank 12 to be discharged via the nozzle 16.

The operating method for the metal bonding apparatus 1 according to the present embodiment is as follows, for example. First, the user holds the metal bonding apparatus 1, and inserts the first bonding portion 202 (see FIG. 2) into the space between the first base 122 and the second base 124. Next, the user presses the solution supply button 8 so as to supply the solution 11 to the first bonding portion 202. Subsequently, the user inserts the second bonding portion 212 (see FIG. 2) into the space between the first bonding portion 202 and the first base 122, and operates the first arm 100 and the second arm 110 such that they turn with the movable unit 102 as an axis. In this state, the second bonding portion 212 comes in contact with the solution 11 supplied to the first bonding portion 202. Subsequently, the user further performs such a pressing operation so as to apply pressure to the first bonding portion 202 and the second bonding portion 212. With such an arrangement, in such a state in which pressure is applied to the first bonding portion 202 and the second bonding portion 212, the first bonding portion 202 and the second bonding portion 212 are pressed in contact with each other by means of the base pair 120. By performing the aforementioned operation, such an arrangement is capable of bonding the first bonding portion 202 and the second bonding portion 212 to each other.

The pressing operation of the metal bonding apparatus 1 according to the present embodiment is similar to that of a stapler. That is to say, such an arrangement allows the user to perform a gripping operation such that the first arm 100 and the second arm 110 approach each other with the movable unit 102 as an axis, thereby providing such a pressing operation. Alternatively, such an arrangement allows the user to press the first arm 100 downward with the movable unit 102 as an axis with the second arm 110 being fixedly placed on a desk or the like, thereby providing such a pressing operation.

With the metal bonding apparatus 1 according to the embodiment 2 described above, such an arrangement provides the same advantages as those of the embodiment 1.

The present invention is not restricted to the aforementioned embodiments. Also, various kinds of modifications such as design modifications may be made based on the knowledge of those skilled in this art, which are also encompassed within the technical scope of the present invention.

Description has been made in the aforementioned embodiments regarding an arrangement in which the first bonding portion and the second bonding portion are each formed of copper. Also, either one of or both of the first bonding portion and the second bonding portion may be formed of a metal other than copper. For example, an arrangement may be made in which the first bonding portion is formed of copper, and the second bonding portion is formed of aluminum. Also, an arrangement may be made in which the first bonding portion is formed of iron, and the second bonding portion is formed of aluminum.

Description has been made in the aforementioned embodiments regarding an arrangement in which heating and pressing is performed so as to provide metal bonding of the first bonding portion and the second bonding portion. Also, ultrasonic waves may be applied instead of heating or pressing. Also, either the heating or pressing may be replaced by applying ultrasonic waves. Also, ultrasonic waves may be applied in addition to the heating and pressing.

It should be noted that the invention according to the present embodiments may be specified according to the items described below.
[Item 1] A metal bonding apparatus comprising:

a solution supply unit configured to supply a solution which is able to elute an oxide with copper oxide as a principal component, to at least one of a first bonding portion and a second bonding portion;

a pressing unit configured to apply pressure to the first bonding portion and the second bonding portion so as to sandwich the solution between the first bonding portion and the second bonding portion, and in a direction in which a distance between the first bonding portion and the second bonding portion is reduced; and

a heating unit configured to heat the first bonding portion and the second bonding portion,

wherein the first bonding portion and the second bonding portion are bonded by the pressure applied by the pressing unit and the heat from the heating unit.
[Item 2] A metal bonding apparatus according to Item 1,

wherein the first bonding portion comprises a first base portion formed of a metal with copper as a principal component and the first coating portion formed of an oxide with copper oxide as a principal component and configured to coat a surface of the first base portion,

wherein the second bonding portion comprises a second base portion formed of a metal with copper as a principal component and the second coating portion formed of an oxide with copper oxide as a principal component and configured to coat a surface of the second base portion, and

wherein the solution supply unit supplies the solution to at least one of the first coating portion and the second coating portion.
[Item 3] A metal bonding apparatus according to Item 1 or 2, wherein the solution supply unit comprises a spray nozzle configured to spray the solution onto at least one from among the first bonding portion and the second bonding portion.
[Item 4] A metal bonding apparatus according to Item 1 or 2, wherein the solution supply unit comprises an inkjet nozzle configured to discharge the solution onto at least one from among the first bonding portion and the second bonding portion.
[Item 5] A metal bonding apparatus according to any one of Items 1 through 4, wherein the solution supply unit comprises a partition configured to enclose a region to which the solution is to be supplied, on at least one from among the first bonding portion and the second bonding portion.
[Item 6] A metal bonding apparatus according to Item 1 or 2, wherein the solution supply unit comprises a container configured to store the solution,

and wherein at least one from among the first bonding portion and the second bonding portion is brought into contact with the solution stored in the container.
[Item 7] A metal bonding apparatus according to Item 6, wherein, from among a first member having the first bonding portion and a second member having the second bonding portion, the member for which a region having the same level as that of the first bonding portion or otherwise the second bonding portion has a smaller area is selected as such a member to be brought into contact with the solution.
[Item 8] A metal bonding apparatus according to Item 1 or 2, wherein the solution supply unit comprises a porous body which is capable of being impregnated with the solution,
   and wherein the porous body impregnated with the solution is pressed into contact with at least one from among the first bonding portion and the second bonding portion.
[Item 9] A metal bonding apparatus according to Item 8, wherein the solution supply unit is configured to introduce the porous body impregnated with the solution between the first bonding portion and the second bonding portion.
[Item 10] A metal bonding apparatus according to Item 1 or 2, wherein the solution supply unit comprises a solution heating unit configured to heat the solution.
[Item 11] A metal bonding apparatus according to any one of Items 1 through 10, further comprising:

a stage on which pressure and heat are applied to the first bonding portion and the second bonding portion;

a first transfer unit configured to transfer a first member having the first bonding portion to the stage; and

a second transfer unit configured to transfer a second member having the second bonding portion to the stage.
[Item 12] A metal bonding apparatus according to Item 1 or 2, further comprising:

a first arm; and

a second arm arranged such that one end side thereof is rotatably connected to one end side of the first arm, and configured to be operated such that the other end side thereof approaches the other end side of the first arm,

wherein the pressing unit comprises a pair of bases respectively provided to a face of the first arm on the other end side and a face of the second arm on the other end side that respectively face each other,

and wherein the pair of bases defines a space which allows the first bonding portion and the second bonding portion to be inserted,

and wherein, by operating the first arm and the second arm such that the other end sides thereof approach each other, the first bonding portion and the second bonding portion inserted into the space are pressed.
[Item 13] A metal bonding apparatus according to Item 12, wherein the solution supply unit comprises:

a solution tank provided to the first arm; and

a nozzle arranged on the other end side of the first arm, and configured to supply the solution stored in the solution tank to at least one from among of the first bonding portion and the second bonding portion inserted into the space.

[Item 14] A metal bonding apparatus according to Item 12 or 13, wherein the heating unit comprises heaters housed in the pair of bases.
[Item 15] A metal bonding apparatus according to any one of Items 1 through 14, wherein the solution contains a ligand that can form a complex with copper.
[Item 16] A metal bonding apparatus according to Item 15, wherein the complex is thermally degradable.
[Item 17] A metal bonding apparatus according to any one of Items 1 through 16, wherein the solution is configured as ammonia water, or otherwise as a carboxylic acid aqueous solution.
[Item 18] A metal bonding apparatus according to Item 17, wherein carboxylic acid contained in the aforementioned carboxylic acid aqueous solution functions as a multidentate ligand.
[Item 19] A metal bonding apparatus according to Item 18, wherein the multidentate ligand forms at least two coordinate bonds with a single copper ion.
[Item 20] A metal bonding apparatus comprising:

a solution supply unit configured to supply a solution which is able to elute an oxide with copper oxide as a principal component, to at least one from among a first coating portion of a first bonding portion that comprises a first base portion formed of a metal with copper as a principal component and the first coating portion formed of an oxide with copper oxide as a principal component and configured to coat a surface of the first base portion, and a second coating portion of a second bonding portion that comprises a second base portion formed of a metal with copper as a principal component and the second coating portion formed of an oxide with copper oxide as a principal component and configured to coat a surface of the second base portion;

a pressing unit configured to apply pressure to the first bonding portion and the second bonding portion in a direction in which a distance between the first bonding portion and the second bonding portion is reduced; and

a heating unit configured to heat the first bonding portion and the second bonding portion,

wherein, in a state in which the first bonding portion and the second bonding portion are pressed and heated, copper on the first bonding portion and copper on the second bonding portion exposed by the solution are bonded to each other.

What is claimed is:

1. A metal bonding apparatus comprising:
a solution supply unit configured to supply a solution which is able to elute an oxide with copper oxide as a principal component, to at least one of a first bonding portion and a second bonding portion;
a pressing unit configured to apply pressure to the first bonding portion and the second bonding portion so as to sandwich the solution between the first bonding portion and the second bonding portion, and in a direction in which a distance between the first bonding portion and the second bonding portion is reduced; and
a heating unit configured to heat the first bonding portion and the second bonding portion,
wherein the first bonding portion and the second bonding portion are bonded by the pressure applied by the pressing unit and the heat from the heating unit.

2. A metal bonding apparatus according to claim 1,
wherein the first bonding portion comprises a first base portion formed of a metal with copper as a principal component and the first coating portion formed of an oxide with copper oxide as a principal component and configured to coat a surface of the first base portion,
wherein the second bonding portion comprises a second base portion formed of a metal with copper as a principal component and the second coating portion formed of an oxide with copper oxide as a principal component and configured to coat a surface of the second base portion, and
wherein the solution supply unit supplies the solution to at least one of the first coating portion and the second coating portion.

3. A metal bonding apparatus according to claim 1, wherein the solution supply unit comprises a spray nozzle configured to spray the solution onto at least one from among the first bonding portion and the second bonding portion.

4. A metal bonding apparatus according to claim 1, wherein the solution supply unit comprises an inkjet nozzle configured to discharge the solution onto at least one from among the first bonding portion and the second bonding portion.

5. A metal bonding apparatus according to claim 1, wherein the solution supply unit comprises a partition configured to enclose a region to which the solution is to be supplied, on at least one from among the first bonding portion and the second bonding portion.

6. A metal bonding apparatus according to claim 1, wherein the solution supply unit comprises a container configured to store the solution,
and wherein at least one from among the first bonding portion and the second bonding portion is brought into contact with the solution stored in the container.

7. A metal bonding apparatus according to claim 6, wherein, from among a first member having the first bonding portion and a second member having the second bonding portion, the member for which a region having the same level as that of the first bonding portion or otherwise the second bonding portion has a smaller area is selected as such a member to be brought into contact with the solution.

8. A metal bonding apparatus according to claim 1, wherein the solution supply unit comprises a porous body which is capable of being impregnated with the solution,
and wherein the porous body impregnated with the solution is pressed into contact with at least one from among the first bonding portion and the second bonding portion.

9. A metal bonding apparatus according to claim 8, wherein the solution supply unit is configured to introduce the porous body impregnated with the solution between the first bonding portion and the second bonding portion.

10. A metal bonding apparatus according to claim 1, wherein the solution supply unit comprises a solution heating unit configured to heat the solution.

11. A metal bonding apparatus according to claim 1, further comprising:
a stage on which pressure and heat are applied to the first bonding portion and the second bonding portion;
a first transfer unit configured to transfer a first member having the first bonding portion to the stage; and
a second transfer unit configured to transfer a second member having the second bonding portion to the stage.

12. A metal bonding apparatus according to claim 1, further comprising:
a first arm; and
a second arm arranged such that one end side thereof is rotatably connected to one end side of the first arm, and configured to be operated such that the other end side thereof approaches the other end side of the first arm,
wherein the pressing unit comprises a pair of bases respectively provided to a face of the first arm on the other end side and a face of the second arm on the other end side that respectively face each other,
and wherein the pair of bases defines a space which allows the first bonding portion and the second bonding portion to be inserted,
and wherein, by operating the first arm and the second arm such that the other end sides thereof approach each other, the first bonding portion and the second bonding portion inserted into the space are pressed.

13. A metal bonding apparatus according to claim 12, wherein the solution supply unit comprises:
a solution tank provided to the first arm; and
a nozzle arranged on the other end side of the first arm, and configured to supply the solution stored in the solution tank to at least one from among of the first bonding portion and the second bonding portion inserted into the space.

14. A metal bonding apparatus according to claim 12, wherein the heating unit comprises heaters housed in the pair of bases.

15. A metal bonding apparatus according to claim 1, wherein the solution contains a ligand that can form a complex with copper.

16. A metal bonding apparatus according to claim 15, wherein the complex is thermally degradable.

17. A metal bonding apparatus according to claim 1, wherein the solution is configured as ammonia water, or otherwise as a carboxylic acid aqueous solution.

18. A metal bonding apparatus according to claim 17, wherein carboxylic acid contained in the aforementioned carboxylic acid aqueous solution functions as a multidentate ligand.

19. A metal bonding apparatus according to claim 18, wherein the multidentate ligand forms at least two coordinate bonds with a single copper ion.

20. A metal bonding apparatus comprising:
a solution supply unit configured to supply a solution which is able to elute an oxide with copper oxide as a principal component, to at least one from among a first coating portion of a first bonding portion that comprises a first base portion formed of a metal with copper as a principal component and the first coating portion formed of an oxide with copper oxide as a principal component and configured to coat a surface of the first base portion, and a second coating portion of a second bonding portion that comprises a second base portion formed of a metal with copper as a principal component and the second coating portion formed of an oxide with copper oxide as a principal component and configured to coat a surface of the second base portion;
a pressing unit configured to apply pressure to the first bonding portion and the second bonding portion in a direction in which a distance between the first bonding portion and the second bonding portion is reduced; and
a heating unit configured to heat the first bonding portion and the second bonding portion,
wherein, in a state in which the first bonding portion and the second bonding portion are pressed and heated, copper on the first bonding portion and copper on the second bonding portion exposed by the solution are bonded to each other.
